(19) United States
(12) Patent Application Publication
(10) Pub. No.: US 2014/0028672 A1
(43) Pub. Date: Jan. 30, 2014

(54) METHOD AND APPARATUS FOR CORRECTING CENTRAL LINE

(71) Applicant: Samsung Electronics Co., Ltd., Suwon-si (KR)

(72) Inventors: Young-taek OH, Seoul (KR); Do-kyoon KIM, Seongnam-si (KR); Jung-bae KIM, Hwaseong-si (KR); Won-chul BANG, Seongnam-si (KR); Young-kyoo HWANG, Seoul (KR)

(21) Appl. No.: 13/935,531

(22) Filed: Jul. 4, 2013

(30) Foreign Application Priority Data
Jul. 27, 2012 (KR) 10-2012-0082790

(51) Int. Cl. G06T 17/10

(52) U.S. Cl. CPC G06T 17/10
USPC 345/420

(57) ABSTRACT

A method and apparatus are provided to correct a central line of a tubular object. The method and apparatus are configured to receive input information to move the central line so that at least a portion of the central line is located in the center of the tubular object. The method and apparatus are configured to fit a form of a region of the tubular object to ellipses when the input information is received. The region is formed by intersection points between a shape of the tubular object and a plane, and the plane comprises a predetermined number of points from among points of the central line. The method and apparatus are configured to correct a location of the central line using a central point of each of the fitted ellipses.

### CROSS-REFERENCE TO RELATED APPLICATIONS

This application claims the benefit under 35 U.S.C. §119(a) of Korean Patent Application No. 10-2012-0082790, filed on Jul. 27, 2012, in the Korean Intellectual Property Office, the disclosure of which is incorporated herein in its entirety by reference.

### BACKGROUND

1. Field

The following description relates to methods and apparatuses for correcting a central line of a tubular object.

2. Description of the Related Art

A central line of a tubular object may be used to perform object modeling or object analysis. In this case, the central line of the tubular object may be estimated by using a predetermined algorithm.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Provided are methods of correcting a central line of a tubular object, which enables a revision of the central line.

Provided are apparatuses for correcting a central line of a tubular object, which enables a revision of the central line.

Provided are computer readable recording media having recorded thereon a program for executing the methods.

Additional aspects will be set forth in part in the description which follows and, in part, will be apparent from the description, or may be learned by practice of the presented embodiments.

In accordance with an illustrative example, there is provided a method to correct a location of a central line of a tubular object. The method includes receiving input information to move the central line so that at least a portion of the central line is located in the center of the tubular object; fitting a form of a region of the tubular object to ellipses when the input information is received, wherein the region is formed by intersection points between a shape of the tubular object and a plane, and the plane includes a predetermined number of points from among points of the central line; and correcting a location of the central line using a central point of each of the fitted ellipses.

In accordance with an illustrative example, there is provided a non-transitory computer readable recording medium having recorded thereon a program for executing the method as described above.

In accordance with another illustrative configuration, there is provided an apparatus to correct a location of a central line of a tubular object. The apparatus includes a user interface unit configured to receive input information to move the central line so that at least a portion of the central line is located in the center of the tubular object; a fitting unit configured to fit a form of a region of the tubular object to ellipses when the input information is received, wherein the region is formed by intersection points between a shape of the tubular object and a plane, and the plane includes a predetermined number of points from among points of the central line; and a correction unit configured to correct a location of the central line using a central point of each of the fitted ellipses.

According to exemplary embodiments of the present invention, a correct central line may be generated because a location of a central line previously estimated with respect to a tubular object may be corrected.

### BRIEF DESCRIPTION OF THE DRAWINGS

These and/or other aspects will become apparent and more readily appreciated from the following description of the embodiments, taken in conjunction with the accompanying drawings of which:

FIG. 1 is a block diagram illustrating an apparatus to correct a central line, according to an illustrative example;

FIG. 2 is a diagram illustrating input information to correct a central line, an estimated central line, and a corrected central line, in accordance with an illustrative example;

FIG. 3 is a diagram illustrating intersection points between a shape of a tubular object and a plane that includes points constituting a first central line, in accordance with an illustrative example;

FIG. 4 is a diagram illustrating an example in which a form of a region formed by intersection points is fitted to an ellipse, in accordance with an illustrative example;

FIG. 5 is a block diagram of a correction unit illustrated in FIG. 1, in accordance with an illustrative example;

FIG. 6 is a diagram that illustrates a plurality of ellipses and central points of the plurality of ellipses, in accordance with an illustrative example;

FIG. 7 is a diagram illustrating an example of a method of inserting a knot, which is performed in a knot insertion unit of FIG. 5, in accordance with an illustrative example; and

FIG. 8 is a flowchart illustrating a method to correct a central line, in accordance with an illustrative example.

Throughout the drawings and the detailed description, unless otherwise described, the same drawing reference numerals will be understood to refer to the same elements, features, and structures. The relative size and depiction of these elements may be exaggerated for clarity, illustration, and convenience

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, description of well-known functions and constructions may be omitted for increased clarity and conciseness.

The units and apparatuses described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

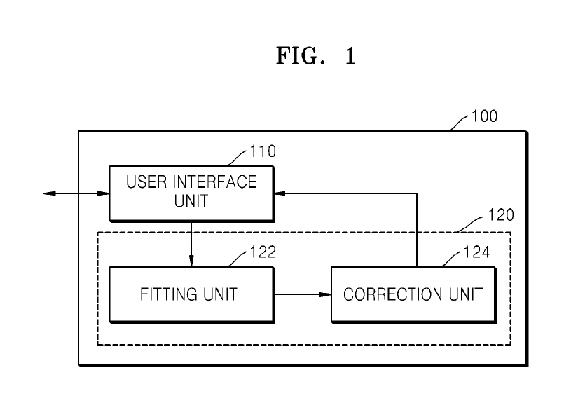

FIG. 1 is a block diagram illustrating an apparatus 100 to correct a central line (hereinafter, referred to as “a central line correction apparatus”), according to an embodiment.

Referring to FIG. 1, the central line correction apparatus 100 includes a user interface unit 110 and a processor 120. The processor 120 includes a fitting unit 122 and a correction unit 124.

It will be understood by those of ordinary skill in the art that other general components other than the components illustrated in FIG. 1 may be included in the central line correction apparatus 10.

The central line correction apparatus 100 corrects a location of a central line estimated with respect to a tubular object. For example, the tubular object may include tubular organs and tissues, such as blood vessels and lymphatic vessels, of the human body, and the central line may be a line indicating a central axis of the tubular object. Below, for convenience of description, the central line estimated with respect to the tubular object is referred to as a first central line and a corrected central line is referred to as a second central line.

The user interface unit 110 displays images. The images include the tubular object and the first central line estimated with the tubular object. In one illustrative example, the images that are displayed on the user interface unit 110 may be images indicating an object for which segmentation has been performed. The images may be obtained by performing image segmentation on a predetermined object in an organ of a patient and photographing the organ. For example, images of blood vessels may be generated by separating images of blood vessels of a liver from images of the liver of the patient. The user interface unit 110 may display the images of the blood vessels. However, in an alternative configuration, the images that are displayed on the user interface unit 110 may be images obtained by photographing an object.

The user interface unit 110 may display the first central line of the tubular object, estimated by using a predetermined algorithm. For example, the predetermined algorithm may include a thinning algorithm or a Voronoi diagram. A position of the first central line of the tubular object may be estimated by applying the predetermined algorithm to the images of the tubular object. However, the estimated position of the first central line according to the predetermined algorithm may not be located at the center of the tubular object due to influence of noise that may exist in the images of the tubular object.

Upon review of the images and the first central line, the user interface unit 110 obtains input information from a doctor or technician, for instance, to move the first central line so that at least a portion of the first central line is located in the center of the tubular object. In one illustrative example, the user interface unit 110 obtains the input information to move the first central line so that at least a portion of the first central line is located at a center of the tubular object. For example, a user, the doctor, or the technician operating the central line correction apparatus 100 may input the input information to move the first central line to the center of the tubular object when at least a portion of the first central line displayed in the user interface unit 110 is not located at the center of the tubular object.

However, the central line correction apparatus 100 is not limited thereto. That is, when it is determined that the first central line is not located in the center of the tubular object, the processor 120 may automatically, without user intervention, correct a location of the first central line. To obtain the input information from the user and provides output information to the user, the user interface unit 110 may include input/output devices, such as a display panel, a mouse, a keyboard, a touch screen, a monitor, a speaker, and the like, and software modules for driving the input/output devices.

In one configuration, the processor 120 may control the entire operation of the central line correction apparatus 100. In another configuration, the processor 120 may control a partial operation of the central line correction apparatus 100. The processor 120 may correct the location of the first central line, estimated with respect to the tubular object, by controlling the fitting unit 122 and the correction unit 124.

When the input information is input to the user interface unit 110, the fitting unit 122 fits a form of a region of the tubular object to an ellipse. The region is formed by intersection points between a shape of the tubular object and a plane. In one illustrative example, the shape may be an outer boundary, an outline, an outer silhouette, a contour, or an outer skin of the tubular object. Also, in one example, the plane includes a predetermined number of points from among points constituting the first central line. In this case, the plane including the predetermined number of points from among the points constituting the first central line may be a plane that is formed in a normal direction to the central line. However, the present configuration is not limited thereto.

As an example of a method to calculate the intersection points performed by the central line correction apparatus 100, the fitting unit 122 measures a radius of the tubular object at the first central line to calculate the intersection points and then performs a windowing operation of a size of about 1.5 times to about 2 times of the measured radius. As a result, the intersection points around the center of the tubular object may be effectively calculated. Alternatively, the fitting unit 122 may perform a growing of a region from the center of the object instead of performing the windowing operation.

As an example of a fitting method performed by the central line correction apparatus 100, to fit the form of the region to the ellipse, the fitting unit 122 may fit an ellipse to the intersection points through an ellipse fitting method based on least squares. However, the present invention is not limited thereto.

Additionally, in the case where the intersection points are defined by a coordinate system, which is formed of the x-axis, the y-axis, and the z-axis, the fitting unit 122 may project each of the intersection points on a plane in which a z-axis value is zero and then may fit projected data to an ellipse. Other similar projections may be appropriate.

Below, an illustrative example is provided where the fitting unit 122 performs a fitting operation through planes including first through N-th points from among a plurality of points constituting a central line. In this example, N is a natural number that is two or more.

Using the ellipse fitting method, the fitting unit 122 fits intersection points between a plane, which includes a first point and is formed in a normal direction to the first central line, and the shape of the tubular object to a first ellipse. Also, using the ellipse fitting method, the fitting unit 122 fits intersection points between a plane, which includes a second point and is formed in normal direction to the first central line, and the shape of the tubular object to a second ellipse. In this manner, the fitting unit 122 fits intersection points between a plane and the shape of the tubular object to an N-th ellipse through the ellipse fitting method. The plane includes an N-th point and is formed in a normal direction to the first central line.

N, which is the number of points which are used to perform a fitting process in the fitting unit 122, may be adjusted in accord with a sampling frequency. For example, depending on the environment of the central line correction apparatus 100, a user of the central line correction apparatus 100 may improve the accuracy of correction by increasing the sampling frequency or may improve the speed of correction by decreasing the sampling frequency. In this case, the sampling frequency may be input through the user interface unit 110, and the processor 120 may perform a correction operation with reference to information input through the user interface unit 110.

The correction unit 124 corrects a location of the first central line using a central point of each of the ellipses fitted in the fitting unit 122. Thus, the first central line may be revised to the second central line. For example, the correction unit 124 corrects the location of the first central line so that a sum of distances between the central point of each of the fitted ellipses and the second central line is minimized.

Additionally, in the case in which the fitting unit 122 projects each of the intersection points on the plane, in which the z-axis value is zero, and then fits projected data to an ellipse, the correction unit 124 calculates a central point of the fitted ellipse in the plane, in which the z-axis value is zero, and projects again the calculated central point on a plane, which is formed by the intersection points. In this manner, the correction unit 124 may correct the location of the first central line through a re-projected central point of the ellipse.

Accordingly, the second central line newly generated according to the correction operation of the correction unit 124 may be further displayed on the user interface unit 110. According to a use environment, the user interface unit 110 may display an image including the tubular object, the first central line, and the second central line. In the alternative, the user interface unit 110 may display an image including the tubular object and the second central line.

In addition, when input information directing a correction of the location of the central line is input through the user interface unit 110, the fitting operation is automatically performed in the fitting unit 122 of the central line correction apparatus 100 and the correction operation is automatically performed in the correction unit 124 of the central line correction apparatus 100.

Accordingly, when the first central line is not located in the center of the tubular object, the central line correction apparatus 100, according to an embodiment, may accurately and effectively correct the location of the first central line estimated according to a predetermined algorithm.

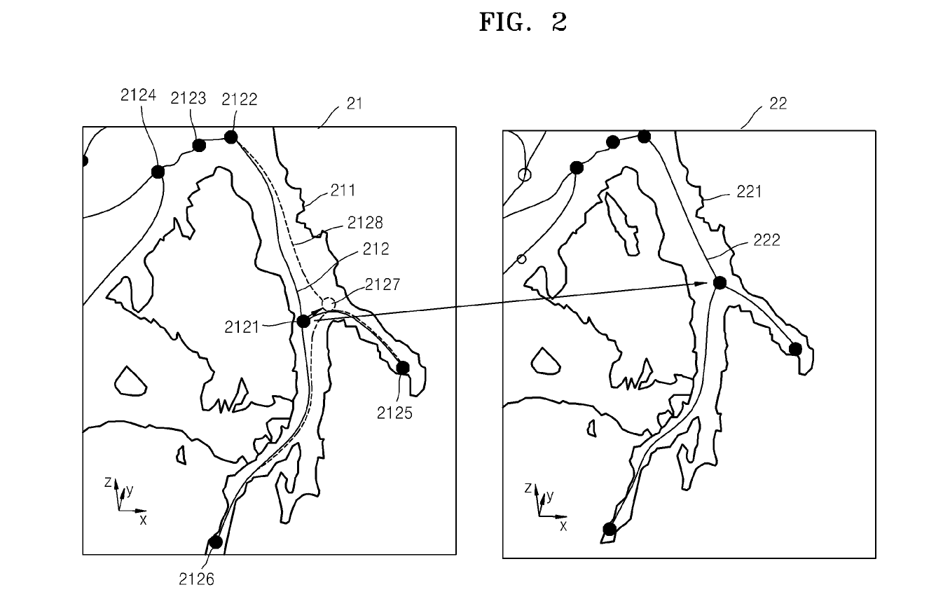

FIG. 2 is a diagram illustrating input information for correcting a central line, an estimated central line, and a corrected central line. A first image 21 and a second image 22 are illustrated in FIG. 2, and the first image 21 and the second image 22 may be displayed on the user interface unit 110.

The first image 21 includes a tubular object 211 and a first central line 212 estimated with respect to the tubular object 211, and the second image 22 includes a tubular object 221 and a second central line 222, which is a corrected central line.

When input information is input through the user interface unit 110 to move the first central line 212 by locating at least a portion of the first central line 212 in the center of the tubular object 211, the central line correction apparatus 100 automatically corrects the location of the first central line 212. Thus, the central line correction apparatus 100 may generate the second central line 222 as a new central line.

For example, a user may input information through the user interface unit 110 to move any one of first through fourth bifurcation points 2121 through 2124. In this case, each of the first through fourth bifurcation points 2121 through 2124 may indicate point from which the first central line 212 starts to branch out to at least two different directions.

The first central line 212 included in the first image 21 may include the first bifurcation point 2121, the second bifurcation point 2122, the third bifurcation point 2123, the fourth bifurcation point 2124, a first end point 2125, and a second end point 2126. Each of the first and second end points 2125 and 2126 may indicate a point at which the first central line 212 ends.

In more detail, a user may input information through the user interface unit 110 to move the first bifurcation point 2121 to a predetermined point 2127. In one example, the predetermined point 2127 indicates a point that is located in the center of the tubular object 211. For example, the user may move a location of the first bifurcation point 2121 to the predetermined point 2127 by using a mouse, a keyboard, a touch panel, or the like. As a result, the first central line 212 would be moved to a new central line 2128. Thus, according to a use environment of the central line correction apparatus 100, the central line correction apparatus 100 may revise a location of any one of the first central line 212 and the new central line 2128 to the second central line 222.

When the input information is obtained through the user interface unit 110, the fitting unit 122 and correction unit 124 of the processor 120 automatically, without user intervention, perform the fitting operation and the correction operation, respectively, on portions connected to the first bifurcation point 2121 of the first central line 212. The portions connected to the first bifurcation point 2121 of the first central line 212 includes a portion connecting the first bifurcation point 2121 with the second bifurcation point 2122, a portion connecting the first bifurcation point 2121 with the first end point 2125, and a portion connecting the first bifurcation point 2121 with the second end point 2126.

Accordingly, the central line correction apparatus 100 may generate the second central line 222 by correcting a location of at least a portion of the first central line 212. That is, the central line correction apparatus 100 may correct a location of at least a portion of the first central line 212, which is not located in the center of the tubular object 211, in the first central line 212 displayed on the user interface unit 110. Thus, data processing may be faster compared to a case where the correction operation is performed with respect to the entire first central line 212.

As described above, the second image 22 includes the tubular object 221 and the second central line 222. The tubular object 221 included in the second image 22 is the same as the tubular object 211 included in the first image 21. In addition, the second image 22 may further include the first central line 212.

Thus, the central line correction apparatus 100 may generate the second central line 222 by correcting the location of the first central line 212 so that the first central line 212 is located in the center of the tubular object 221, and may display the generated second central line 222. However, other alternative configurations may be possible. For example, the central line correction apparatus 100 may correct the location of the first central line 212 by enabling a user to select an icon directing a correction of a central line displayed on the user interface unit 110. Alternatively, the central line correction apparatus 100 may automatically, without user intervention, correct the location of the first central line 212 when it is determined that a portion of the first central line 212 is not located in the center of the tubular object 211.

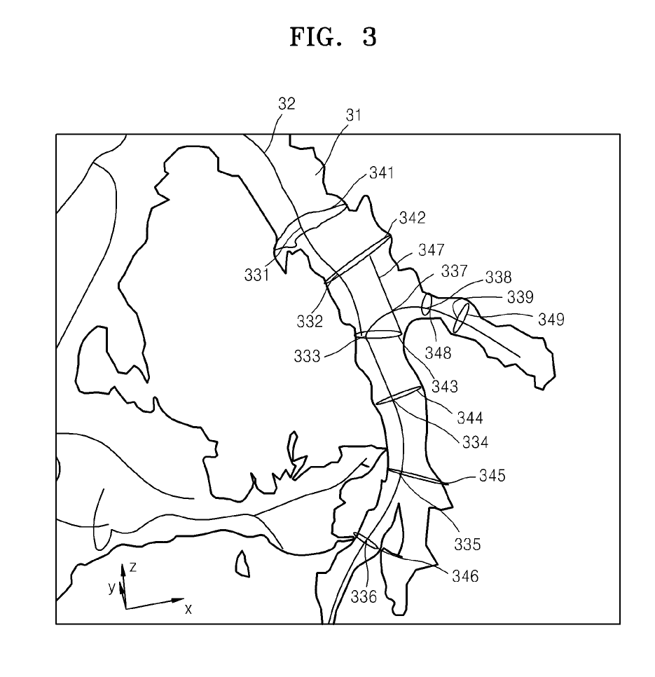

FIG. 3 is a diagram illustrating intersection points between a shape of a tubular object 31 and a plane that includes points constituting a first central line 32.

Referring to FIGS. 1 and 3, the fitting unit 122 fits a form of a region to ellipses. A region is formed by intersection points between a shape of the tubular object 31 and a one of the planes 341 to 349 including each of a predetermined number of points 331 through 339 from among points constituting the first central line 32. As an example, FIG. 3 illustrates the predetermined number of points being nine points; however, the number of predetermined points may vary.

A first plane 341 may include a first point 331 and may be formed in a normal direction to a first central line 32. A second plane 342 may include a second point 332 and may be formed in normal direction to the first central line 32. In this manner, third through ninth planes 343 through 349 may be formed including corresponding points.

The fitting unit 122 calculates intersection points between the first plane 341 and the shape of the tubular object 31, and calculates intersection points between the second plane 342 and the shape of the tubular object 31. In addition, the fitting unit 122 calculates intersection points between each of the third through ninth planes 343 through 349 and the shape of the tubular object 31. In one example, the shape of the tubular object 31 may be a boundary or outline of the tubular object 31. The fitting unit 122 fits a form of a region to ellipses, which is formed by the intersection points for each of the first through ninth planes 341 through 349.

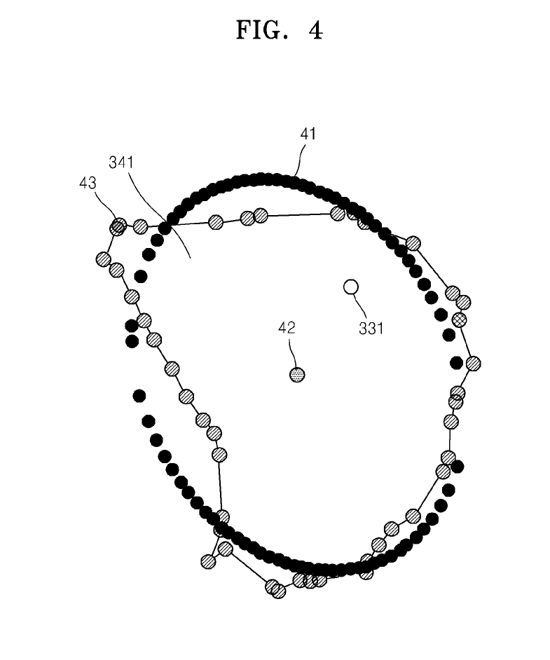

FIG. 4 is a diagram illustrating an example in which a form of a region formed by intersection points is fitted to an ellipse. For convenience of description, the first point 331 illustrated in FIG. 3 and intersection points 43 for the first plane 341 illustrated in FIG. 3 are described below as an example. However, the example of FIG. 4 may be applied to the second through ninth planes 342 through 349 including the second through ninth points 332 through 339, respectively.

Referring to FIGS. 1, 3, and 4, the fitting unit 122 fits a form or shape of a region formed by the intersection points 43 of the first plane 341 to a first ellipse 41, and the correction unit 124 calculates a first central point 42 of the fitted first ellipse 41. In addition, in the same manner, the correction unit 124 may further calculate second through ninth central points of second through ninth ellipses fitted by the fitting unit 122, and may correct the location of the first central line 32 using the calculated first through ninth central points.

In one illustrative example, the intersection points 43 for the first plane 341 illustrated in FIG. 4 are points in a case where intersection points for the first plane 341, as illustrated in FIG. 3, are projected on a plane in which a z-axis value is zero. However, the present configuration is not limited thereto. For the illustrative example, the correction unit 124 calculates the first central point 42 of the first ellipse 41 fitted in the plane in which the z-axis value is zero, and projects again the calculated first central point 42 of the first ellipse 41 on the first plane 341 illustrated in FIG. 3. The correction unit 124 then corrects the location of the first central line 32 using the re-projected first central point 42.

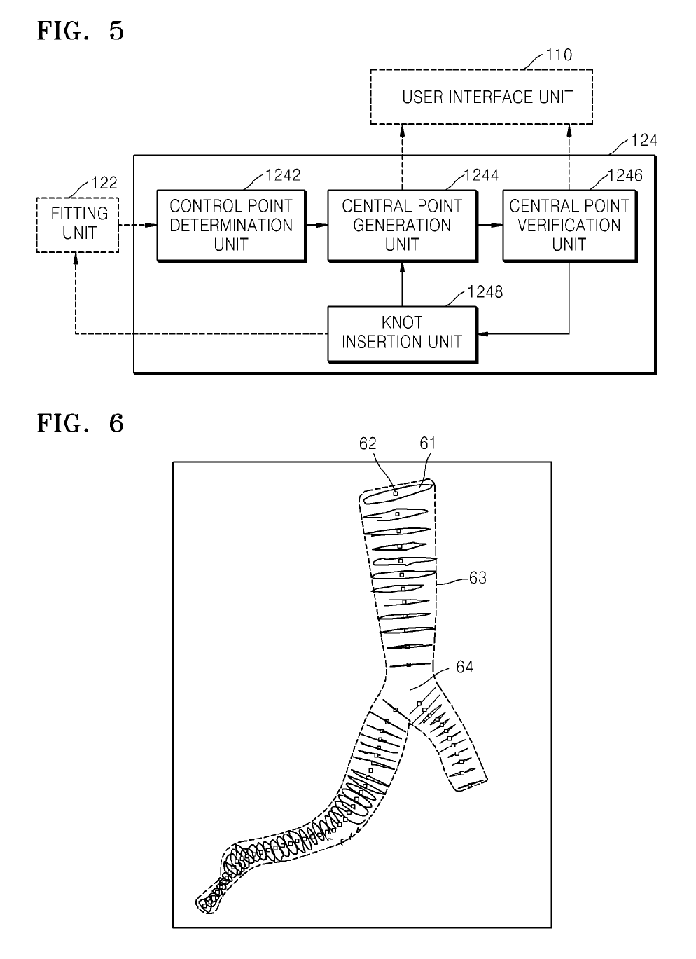

FIG. 5 is a block diagram of the correction unit 124 illustrated in FIG. 1, in accordance with an illustrative example.

Referring to FIG. 5, the correction unit 124 includes a control point determination unit 1242, a central point generation unit 1244, a central point verification unit 1246, and a knot insertion unit 1248.

The correction unit 124 illustrated in FIG. 5 corresponds to an example of the correction unit 124 illustrated in FIG. 1. Accordingly, because the above description of the correction unit 124 illustrated in FIG. 1 may be applied to the correction unit 124 of FIG. 5, a description thereof is incorporated herein. In addition, the correction unit 124 is not limited to the units illustrated in FIG. 5. Other units, processors, or controllers may be equally and additionally implemented.

The correction unit 124 corrects the location of the first central line using central points of the ellipses fitted in the fitting unit 122. For example, the correction unit 124 corrects the location of the first central line and, thereby, generate the second central line so that a sum of a distance between the central point of each of the ellipses and the second central line is minimized.

When it is assumed that a central line of the tubular object has a B-Spline curve or a Bezier curve, the correction unit 124 corrects the location of the first central line and, thereby, generate the second central line by moving control points that parameterize the first central line.

The control point determination unit 1242 determines control points that parameterize a curve from which the sum of distance to the central point of each of the ellipses is minimized. For example, the control point determination unit 1242 determines control points of a curve from which the sum of distance to the central point of each of the ellipses is minimized, from among a plurality of control points that parameterize curves, which may exist in a tubular space formed by the ellipses.

The central point generation unit 1244 generates the second central line based on the control points determined by the control point determination unit 1242. For example, assuming that a set of the control points is “X” and a parameter is “t”, a curve that is parameterized by “X” and “t” may be defined by C(X, t). In this case, “X” includes control points that have an influence on the shape of the curve C(X, t). The parameter “t” indicates a domain [t tₘₐₓ] of the curve C(X, t). When the curve C(X, t) is the B-Spline curve, the range of the parameter “t” may be determined by a knot. In this case, the control point determination unit 1242 determines the control points by performing operations such as Equations 1 and 2, and the central point generation unit 1244 generates the second central line using the determined control points.

$${X}^{′} = {arg min}_{X} {E}_{fitting} ( X ) \qquad ( 1 )$$

In Equation 1, “X′” indicates a set of control points determined by the control point determination unit 1242, “E_{fitting}(X)” indicates a fitting energy term, and “X” indicates a set of control points that parameterize any one of curves that may exist in a tubular space.

In this case, the fitting energy term “E_{fitting}(X)” may indicate the sum of the distance between a curve parameterized by “X”, from among curves that may exist in a tubular space formed by ellipses, and the central point of each of the ellipses. By applying an example of the fitting energy term “E_{fitting}(X)”, the control point determination unit 1242 may determine the control points using Equation 2.

$${X}^{′} {arg min}_{X} {\sum }_{i = {t}_{min}}^{{t}_{max}} \vert \vert Ellipse Center ( C ( X , {t}_{i} ) ) - C ( X , {t}_{i} ) {\vert \vert}^{2} \qquad ( 2 )$$

In Equation 2, “X′” indicates a set of control points determined by the control point determination unit 1242, “t” indicates a parameter, “X” indicates a set of control points that parameterize any one of curves that may exist in a tubular space, and “t,” indicates a point on a domain of a curve “C(X, t)”. “C(X,tᵢ)” indicates a point that is defined by “t,” from among points constituting the curves, which may exist in the tubular space formed by ellipses, and “EllipseCenter(C(X,tᵢ))” indicates a point that is defined by “C(X,tᵢ)” from among central points of the ellipses.

In addition, ellipses that are fitted in the fitting unit 122 may be determined by the parameter “t”. For example, when the parameter “t” is defined by {0.1, 0.2, 0.3, . . . , 1.0}, the ellipses that are fitted in the fitting unit 122 exist in planes including {C(X,0), C(X,0.1), C(X,0.2), C(X,0.3), . . . , C(X,1.0)}, which are points on the domain of the curve “C(X, t)”.

Accordingly, in one illustrative example, the control point determination unit 1242 changes “X”, which is the set of control points, and determines “X′”, indicating a set of control points of a curve from which the sum of the distance to the central point of each of the ellipses is minimized, from among the curves which may exist in the tubular space formed by the ellipses. The central point generation unit 1244 determines the second central line by using “X′”.

Additionally, the control point determination unit 1242 determines the control points by further considering a degree of uniformity of the distance between control points that parameterize each of the curves, which may exist in the tubular space formed by the ellipses, a length of each of curves to be parameterized by the control points, or a combination thereof.

In this case, the control point determination unit 1242 determines the control points by performing an operation such as Equation 3, and the central point generation unit 1244 generates the second central line using the determined control points.

$${X}^{′} = {arg min}_{X} ( {E}_{fitting} ( X ) + {E}_{reg} ( X ) ) \qquad ( 3 )$$

Equation 3 is obtained by further adding a regularization energy term Ereg(X) to Equations 1 and 2. The descriptions of Equations 1 and 2 presented above are incorporated herein. The regularization energy term Ereg(X) allows the second central line not to be leaned to one side.

As the regularization energy term Ereg(X) exists, the control point determination unit 1242 may determine control points of a curve, which the sum of the distance between the curve to the central point of each of the ellipses, a value indicating a degree of uniformity of the distances between the control points parameterizing the curve, and length of the curve to be parameterized by the control points is minimized. For example, the control point determination unit 1242 determines control points of the curve satisfying conditions in which the sum of the distance between the curve and the central point of each of the ellipses is small, the distances between the control points are uniform, and the length of the curve to be parameterized by the control points are short. In this manner, the control point determination unit 1242 performs an optimization operation to determine the control points that parameterize the second central line.

The central point verification unit 1246 determines whether to correct the second central line again based on a comparison result. The comparison result is obtained by comparing the sum of distance between the second central line generated by the central point generation unit 1244 and the central point of each of the ellipses with a first threshold value. Below, for convenience of description, a re-corrected second central line is referred to as a third central line.

In one illustrative example, the central point verification unit 1246 determines that it is not necessary to re-correct the location of the second central line when a distance between the second central line and a central point of each of the ellipses is sufficiently short. In this case, the central point verification unit 1246 transmits the second central line to the user interface unit 110, and the user interface unit 110 displays the second central line.

As an another example, the central point verification unit 1246 may determine that the second central line is not located in the center of the tabular object when the distance between the second central line and the central point of each of the ellipses is not sufficiently short. Thus, the central point verification unit 1246 determines that the second central line has to be re-corrected when the sum of the distance between the second central line and the central point of each of the ellipses is equal to or greater than the first threshold value.

When re-correcting the second central line, the knot insertion unit 1248 inserts at least one additional knot in a set of knots parameterizing the second central line taking into consideration the distance between the central point of each of the ellipses and the second central line. The number of control points that parameterize a curve may be increased as the at least one additional knot is inserted in the set of knots.

However, although, when the central line is defined by the B-Spline curve, the central line correction apparatus 100 increases the number of control points by inserting the at least one additional knot in the set of knots, the present configuration is not limited thereto. For example, when the central line is defined by the Bezier curve, the central line correction apparatus 100 may increase the number of control points without using a knot. In this case, the knot insertion unit 1248 may operate as a control point insertion unit. For example, the knot insertion unit 1248 may insert the at least one additional knot in the set of knots, which parameterize the second central line, using a knot insertion algorithm.

As another example, the knot insertion unit 1248 may insert the at least one additional knot in the set of knots using Greville Abscissaes. The knot insertion unit 1248 calculates Greville Abscissaes for the second central line, and calculates middle points between the calculated Greville Abscissaes. In addition, the knot insertion unit 1248 calculates a distance between each of the calculated middle points and a central point of an ellipse corresponding thereto. The knot insertion unit 1248 adds a new knot to the set of knots in correspondence to a corresponding middle point when the calculated distance is equal to or greater than a second threshold value. In this case, the knot insertion unit 1248 may use a knot insertion algorithm to add the new knot to the set of knots.

Thus, the fitting unit 122 fits a form of a region to ellipses. The region is formed by intersection points between a plane and the shape of the tubular object. The plane includes each of the points defined according to the set of knots, in which the new knot is inserted by the knot insertion unit 1248, from among points constituting the first central line. The correction unit 124 generates the third central line by correcting the location of the second central line using the central points of the fitted ellipses.

Thus, the correction unit 124 transmits the third central line generated in the central point generation unit 1244 to the user interface unit 110, and the user interface unit 110 displays the third central line.

However, when fast data processing is needed according to a use environment, the central point verification unit 1246 and the knot insertion unit 1248 may not operate, or the correction unit 124 may not include the central point verification unit 1246 and the knot insertion unit 1248. The knot insertion unit 1248 is included in the correction unit 124

FIG. 6 is a diagram illustrating a plurality of ellipses and central points of the plurality of ellipses. Referring to FIG. 6, a first ellipse 61 and a central point 62 of the first ellipse are illustrated. The central line correction apparatus 100 may correct a location of a first central line of a tubular space 63 using the plurality of ellipses and the central points of the plurality of ellipses and, thus, generate a second central line of the tubular space 63.

Referring to FIGS. 5 and 6, the control point determination unit 1242 determines control points of a curve from which the sum of the distance to the central point of each of the plurality of ellipses is minimized, from among a plurality of control points that parameterize curves that may exist in the tubular space 63 formed by the plurality of ellipses. In this case, according to a use environment, the control point determination unit 1242 may divide the tubular space 63 formed by the plurality of ellipses into two or three spaces based on a bifurcation point 64. The control point determination unit 1242 may also determine control points of the divided spaces. However, the present configuration is not limited thereto.

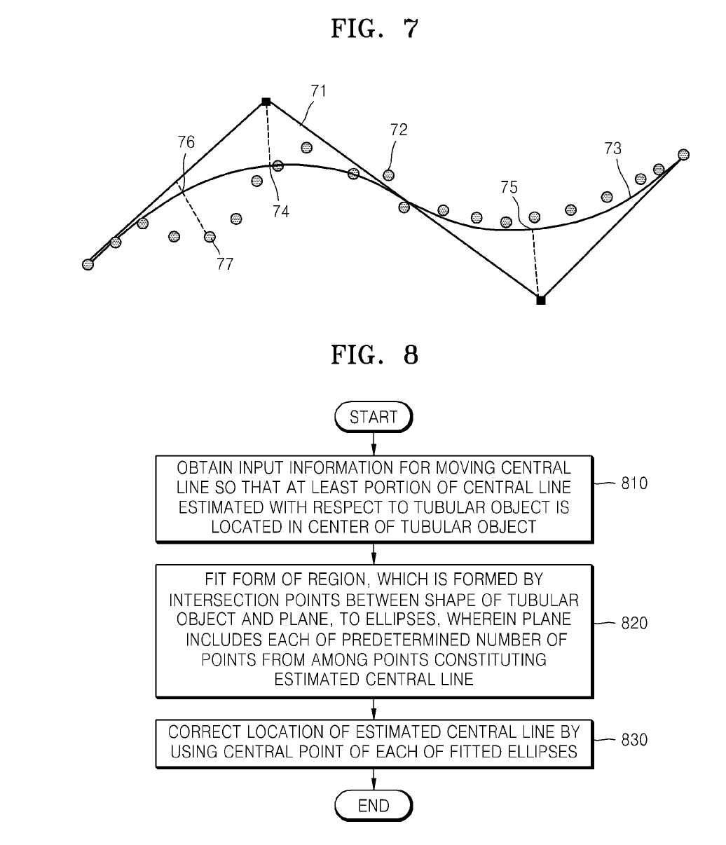

FIG. 7 is a diagram illustrating an example of a method of inserting a knot, which is performed in the knot insertion unit 1248 of FIG. 5.

Referring to FIG. 7, this figure illustrates a line 71 connects control points, a line 72 connects central point of each of a plurality of ellipses, and a second central line 73 parameterized by the control points.

For example, when a first point 74 and a second point 75 are Greville Abscissaes, a third point 76 may be a middle point between the Greville Abscissaes. In this case, the knot insertion unit 1248 calculates a distance between the third point 76 and a central point 77 of an ellipse corresponding to the third point 76. The knot insertion unit 1248 adds a new knot corresponding to the third point 76 to a set of knots when the calculated distance is equal to or greater than the second threshold value.

As a result of the knot insertion unit 1248 inserting a new knot in the set of knots, a correct central line may be obtained when a curve expression of a central line does not properly indicate the central line.

FIG. 8 is a flowchart illustrating a method to correct a central line, according to an embodiment.

Referring to FIG. 8, the method includes operations that are processed in the central line correction apparatus 100 illustrated in FIG. 1. Accordingly, although omitted below, the above description of the central line correction apparatus 100 illustrated in FIG. 1 may be applied to the method of FIG. 8.

In operation 810, the user interface unit 110 obtains input information to move a central line so that at least a portion of the central line estimated with respect to a tubular object is located in the center of the tubular object.

In operation 820, when the input information is obtained, the fitting unit 122 fits a form of a region to ellipses. The region is formed by intersection points between a shape of the tubular object and a plane. The plane includes each of a predetermined number of points from among points constituting the estimated central line.

In operation 830, the correction unit 124 corrects a location of the estimated central line by using central point of each of the fitted ellipses.

Thus, according to the current embodiment, an automated method to correct an error of a central line estimated according to a predetermined algorithm is provided. In addition, a method to correct a location of a central line is provided. The method may be interactive with a user as the user adjusts a sampling frequency for correcting the location of the central line.

In addition, when an object modeling or a modeling for an organ including an object is performed using the method according to the various embodiments described above, the accuracy of modeling may be improved. As a result, the method according to the various embodiments described above may be used in a tumor tracking and matching operation.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

It is to be understood that in the embodiment of the present invention, the operations in FIG. 8 are performed in the sequence and manner as shown although the order of some steps and the like may be changed without departing from the spirit and scope of the present invention. In accordance with an illustrative example, a computer program embodied on a non-transitory computer-readable medium may also be provided, encoding instructions to perform at least the method described in FIG. 8.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A method to correct a location of a central line of a tubular object, the method comprising:
receiving input information to move the central line so that at least a portion of the central line is located in the center of the tubular object;
fitting a form of a region of the tubular object to ellipses when the input information is received, wherein the region is formed by intersection points between a shape of the tubular object and a plane, and the plane comprises a predetermined number of points from among points of the central line; and
correcting a location of the central line using a central point of each of the fitted ellipses.

2. The method of claim 1, wherein the central line is estimated with respect to the tubular object and the correcting of the location comprises correcting the location of the estimated central line to minimize a sum of a distance between the central point of each of the fitted ellipses and the corrected central line.

3. The method of claim 1, wherein the correcting of the location comprises:
determining control points that parameterize a curve to minimize a sum of a distance to the central point of each of the fitted ellipses; and
generating a corrected central line based on the determined control points.

4. The method of claim 3, wherein the determining of the control points comprises determining control points of the curve to minimize the sum of the distance to the central point of each of the ellipses, among control points that parameterize curves in a tubular space formed by the ellipses.

5. The method of claim 4, wherein the determining of the control points is performed based on a degree of uniformity of distances between the control points parameterizing each curve, a length of each curve to be parameterized by the control points, or a combination thereof.

6. The method of claim 5, wherein the determining of the control points comprises determining the control points of the curve based on a sum of a value indicating the degree of uniformity of the distances between the control points parameterizing the curve, the sum of the distance between the curve and central point of each of the fitted ellipses, and a length of the curve to be parameterized by the control points is minimized.

7. The method of claim 1, wherein the correcting of the location comprises determining whether to re-correct the corrected central line based on a comparison result obtained by comparing a sum of a distance between the corrected central line and the central point of each of the fitted ellipses with a threshold value.

8. The method of claim 7, wherein the central line is estimated with respect to the tubular object and, when re-correcting the corrected central line, the correcting of the location further comprises inserting at least one additional knot in a set of knots parameterizing the corrected central line based on the distances between the central point of each of the ellipses and the corrected central line, wherein the plane comprises points that are defined according to the set of knot, in which the at least one additional knot is inserted, from among the points of the estimated central line.

9. The method of claim 1, wherein the obtaining of the input information comprises receiving input information to move a bifurcation point of the central line, and the fitting of the form and the correcting of the location are performed with respect to portions connected to the bifurcation point of the central line.

10. The method of claim 1, wherein the fitting of the forms and the correcting of the location are automatically performed when the input information is received.

11. The method of claim 1, wherein the region is formed by intersection points between the shape of the tubular object and at least one additional plane, wherein each of the plane and the at least one additional plane comprises each of the predetermined number of points from among the points of the central line.

12. A non-transitory computer readable recording medium having recorded thereon a program for executing the method of claim 1.

13. An apparatus to correct a location of a central line of a tubular object, the apparatus comprising:
a user interface unit configured to receive input information to move the central line so that at least a portion of the central line is located in the center of the tubular object;
a fitting unit configured to fit a form of a region of the tubular object to ellipses when the input information is received, wherein the region is formed by intersection points between a shape of the tubular object and a plane, and the plane comprises a predetermined number of points from among points of the central line; and
a correction unit configured to correct a location of the central line using a central point of each of the fitted ellipses.

14. The apparatus of claim 13, wherein the central line is estimated with respect to the tubular object and the correction unit is further configured to correct the location of the estimated central line to minimize a sum of a distance between the central point of each of the fitted ellipses and the corrected central line.

15. The apparatus of claim 13, wherein the correction unit comprises:
a control point determination unit configured to determine control points which parameterize a curve to minimize a sum of a distance to the central point of each of the fitted ellipses; and
a central point generation unit configured to generate a corrected central line based on the determined control points.

16. The apparatus of claim 15, wherein the control point determination unit determines control points of the curve to minimize the sum of the distance to the central point of each of the ellipses, among control points that parameterize curves in a tubular space formed by the ellipses.

17. The apparatus of claim 16, wherein the control point determination unit determines the control points based on a degree of uniformity of distances between control points parameterizing each curve, a length of each curve to be parameterized by the control points, or a combination thereof.

18. The apparatus of claim 17, wherein the control point determination unit determines the control points of the curve based on a sum of a value indicating the degree of uniformity of the distances between the control points parameterizing the curve, the sum of distance between the curve and the central point of each of the fitted ellipses, and a length of the curve to be parameterized by the control points is minimized.

19. The apparatus of claim 13, wherein the correction unit comprises a central line verification unit that determines whether to re-correct the corrected central line based on a comparison result obtained by comparing a sum of a distance between the corrected central line and the central point of each of the fitted ellipses with a threshold value.

20. The apparatus of claim 19, wherein the central line is estimated with respect to the tubular object, and the correction unit further comprises
a knot insertion unit, when re-correcting the corrected central line, configured to insert at least one additional knot in a set of knots parameterizing the corrected central line based on the distance between the central point of each of the ellipses and the corrected central line, wherein the plane comprises points that are defined according to the set of knot, in which the at least one additional knot is inserted, from among the points of the estimated central line.

21. The apparatus of claim 13, wherein the user interface unit is further configured to display images comprising the tubular object and the central line estimated with respect to the tubular object and displays the corrected central line on the images.

22. The apparatus of claim 13, wherein the region is formed by intersection points between the shape of the tubular object and at least one additional plane, wherein each of the plane and the at least one additional plane comprises each of the predetermined number of points from among the points of the central line.
